(19) United States
(12) Patent Application Publication
(10) Pub. No.: US 2013/0323702 A1
(43) Pub. Date: Dec. 5, 2013

(54) METHODS AND APPARATUS FOR DISTRIBUTING AND CONTROLLING THE DISTRIBUTION OF KARAOKE SHOW SONGS

(71) Applicant: David Arthur Casto, Columbus, OH (US)

(72) Inventor: David Arthur Casto, Columbus, OH (US)

(21) Appl. No.: 13/485,874

(22) Filed: May 31, 2012

(51) Int. Cl. G09B 15/00

(52) U.S. Cl. 434/307 A

(57) ABSTRACT

A system, method and software allows a karaoke host's music collection to reside in one physical location (such as a CD server) or as a digital copy (on a central server) and all the music can be accessed via client karaoke hosting software. When a client karaoke show hosting application is playing a song from the central client/server, the software marks that song as being “checked out” while it is being played/in use. This keeps that song from being able to be played by multiple hosts at the same time. Discs or digital files are able to be stored centrally, preventing loss or damage, and multiple clients can use the same karaoke collection without violating licensing laws. The software allows the discs to be stored centrally, avoiding the need to carry them to shows and manually handle them, thereby minimizing the risk of lost, damaged, or stolen discs.

### BACKGROUND OF THE INVENTION

The present invention relates to karaoke systems and methods and more particularly, to software that allows songs to be distributed directly to karaoke show hosting client software via the internet where songs are checked out and therefore cannot be used at multiple clients at the same time.

Currently, karaoke hosts are required to bring their karaoke music collection on CDs to each show. Hosts can have their disks damaged, stolen or lost. If this happens, many karaoke recording labels do not support a digital option to replace these lost CDs because digital collections can lead to serialization, where multiple copies of the karaoke songs appear on many systems, without there being a one-to-one copy of the original discs/songs in the host's collection.

The burden of discs in this day and age is unfair to karaoke hosts. Karaoke collections can be thousands of discs and sorting through them all as people request songs is time consuming, and discs easily become lost, damaged or stolen.

Existing software for karaoke shows are designed to access songs that are on the local hard drive. Even if the karaoke hosts access their music from a central server via a networked hard drive, there are no means of ensuring that the same song is not being used at multiple locations, and therefore, could lead to serialization or unfair duplication or use of licensed karaoke music at multiple locations.

As can be seen, there is a need for an improved system, method and software that can allow karaoke hosts to work without having to carry their library of discs with them, with songs delivered from a central location via the internet, where the method, system and software includes mechanisms to prevent multiple locations from playing the same song at the same time.

### SUMMARY OF THE INVENTION

In one aspect of the present invention, a karaoke system comprises a central terminal having a central library of songs; one or more karaoke host terminals linked to the central library by a data exchange mechanism; and software disposed in the central terminal, the software being written in computer code and stored on a computer readable medium, the software including program code for sending a requested song to the karaoke host terminal and marking that song as checked out, preventing additional karaoke host terminals from accessing the song.

In another aspect of the present invention, a computer-implemented method, written as a programmable code, stored on a computer readable medium, and adapted to manage operations of a karaoke system, comprises linking one or more karaoke host terminals with a central terminal; receiving a request for a song from a first karaoke host terminal; downloading the song to the first karaoke host terminal; marking the song as being checked out while the song is downloaded at the host terminal, thereby preventing another host terminal from downloading the song; and deleting the song from the host terminal after the song is finished.

In a further aspect of the present invention, a method for preventing unauthorized playing of a karaoke song on multiple karaoke host terminals at multiple locations at the same time comprises linking one or more karaoke host terminals located at multiple locations with a central “command” terminal; receiving a request for a song from a first karaoke host terminal at a first location; downloading the song to the first karaoke host terminal which requested that song; and then marking the song as being checked out while the song is downloaded to the host terminal, thereby preventing another host terminal at another location from downloading the song; and deleting the song from the host terminal after the song is finished.

These and other features, aspects and advantages of the present invention will become better understood with reference to the following drawings, description and claims.

### BRIEF DESCRIPTION OF THE DRAWINGS

FIG. 1 is a schematic system overview drawing showing the relationship of a central store interacting with multiple karaoke hosts, according to an exemplary embodiment of the present invention; and

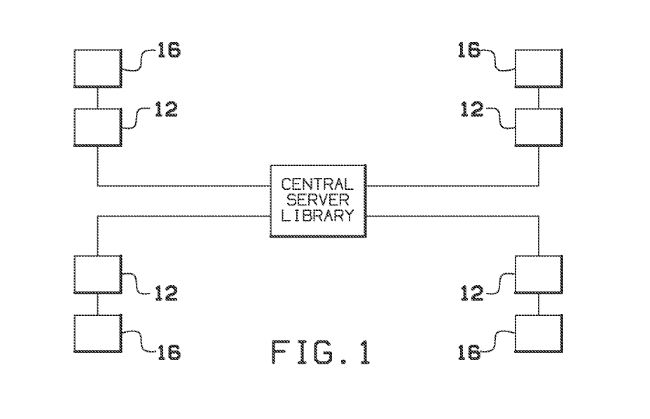

FIG. 2 is an exemplary screen shot showing a display of the software of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system, method and software that allows a karaoke host's music collection to reside in one physical location (such as a CD server) or as a digital copy (on a central server) and all the music can be accessed via client karaoke hosting software. When a client karaoke show hosting application is playing a song from the central client/server, the software marks that song as being “checked out” while it is being played/in use. This keeps that song from being able to be played by multiple hosts at the same time. Discs or digital files are able to be stored centrally, preventing loss or damage, and multiple clients can use the same karaoke collection without violating licensing laws. The software allows the discs to be stored centrally, avoiding the need to carry them to shows and manually handle them, thereby minimizing the risk of lost damaged or stolen discs.

As discussed in greater detail below, the client show hosting software needs to be able to communicate with the central server and the central located music library. The central server needs to be able to deliver the requested music file to the client. The song, while in use on the host client, needs to be marked as in use or “checked out” and not be available to other show hosts clients. The ability to not make multiple copies of songs being used on client show hosts will allow multiple show hosts to share a common central music library while respecting the license agreement of that music library. By centrally locating the music library, it is no longer duplicated among multiple show hosts, and the need to place an unfair burden on the hosts of carrying physical CDs to each show is removed.

Referring now to the Figures, a karaoke system 10 can include a karaoke show hosting client software may reside on karaoke host terminals 12. The karaoke host terminals 12 may be linked through various data exchange connections, such as via the internet, or some other form of a wide area network for example, to a central library 14 to allow songs to be transferred to the karaoke host terminals 12 as requested by the karaoke hosts. A song is requested to be played for someone at a show is first retrieved from the central library 14 and delivered to the karaoke host terminal 12. Then the song is played via the AN output of karaoke host terminal 12 into the attached video and sound output equipment 16.

To obtain a song, the software client in the karaoke host terminal 12 makes a request via the network/internet to access the central library 14 (also referred to as the central server 14) and request that the song from the music collection be provided to the server software at that particular karaoke site. The hosting client software downloads the song in the library from the central server 14 via the internet, for example, and marks that song as “checked out” or in use on the central server 14 so that no other karaoke host terminal 12 can be using that song from the central library 14 at the same time.

Once the song is completed, it is deleted from the cache of the hosting client software and the central server 14 is told via the web/network that the song from the library is once again available to be used. In other words, after the song is completed, it is “checked back in” via the hosting client software.

As described above, the software allows the karaoke music library to be centrally stored, either digitally or as the original CDs or in any combination thereof. The software allows the music to reside in only one location, yet lets it be accessed by multiple karaoke show hosting clients at the same time without serializing or duplicating the karaoke collection at multiple locations. By allowing the music library to be accessed over the web/internet/network, and by marking each song from the collection as being “checked out” or in use so that no other client show host can use the same song at the same time, a karaoke collection can be stored once and shared at multiple shows, avoiding needing to carry CDs or create multiple copies of the library, while not allowing two client show hosts to play the song at the same time.

The software (1) keeps a catalog of the music library; (2) keeps the music library in one centralized location; (3) allows the music library to be accessed over a network or the internet without creating multiple copies of those songs across multiple locations; (4) marks songs in use as being “checked out” so multiple show hosts cannot use the same song at the same time; and (6) deletes the song from the show host computer and informs the central server that the song is once again available for use (is “checked back in”) after the song has finished playing.

The show host client software could also be used for the addition of newly purchased or added tracks to the central server and the central located music library. The centralized music library could be accessed in the field to look for similar songs if a song is marked checked out.

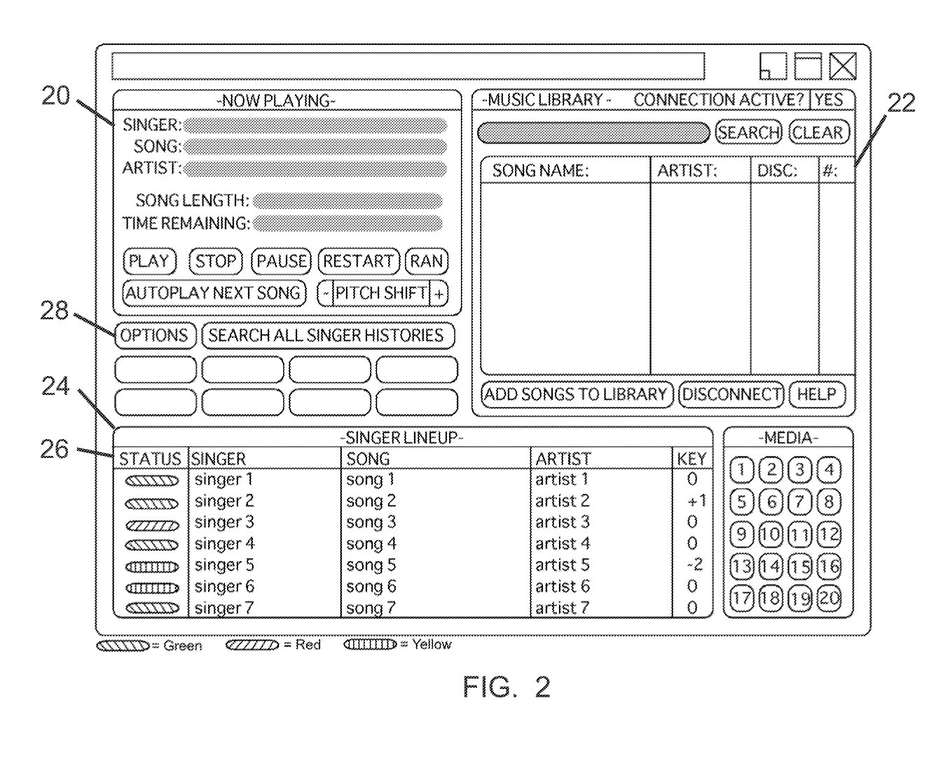

Referring to FIG. 2, an exemplary screen shot of the software application of the present invention is shown. The software may include a currently being played area 20, where a karaoke host may see the song being played, the time left, and be able to pause, stop, play or restart the song. A search box may be provided to search for songs in the central library. The search may be local, where the search checks local files for information such as titles, artists, track names, disc numbers, and the like. In some embodiments, the search may be sent out to the central library to search for the song. The central library may reside on a server, be cloud-based, be physical CD based, or the like.

Once the requested song is found, it may be transferred to the upcoming play list area. The songs that are “checked out” may include a status indicator in the status column 26 that shows, for example a red illumination. In some embodiments, songs currently available may be shown with no illumination or may be positively identified with a green illumination. These colors are strictly chosen for example purposes only and may vary within the scope of the present invention. In some embodiments, a third status indicator may be present, such as yellow illumination that may indicate that the same song appears on multiple karaoke host terminals as being next in queue for playing, allowing the host to adjust the rotation and potentially avoid getting a red illumination/not being able to download/use that song because it is in use at another terminal.

Additional buttons 28 may be provided on the software. For example, there may be a button to set-up an internet connection to remove karaoke host terminals. There may be a button to change the screen over to monitor the karaoke hosts and the songs they are playing. There may be a button to generate reports. Such reports may, for example, show songs that may be blocked by use at one location while checked out at another. This may help the karaoke system owner to decide whether to purchase a second or third copy of a particularly popular song title. An administration button may also be present in the software. This may be used to adjust various screen layout options or to set priority levels to karaoke hosts, or the like. There may also be button that allow the host to play media files (sound effects, screen shots, photos, or movie clips/videos) to further enrich the karaoke experience.

The software of the present invention may be written in any one or more programming languages. In some embodiments, the software may be designed to operate on a computer system, having a central processing unit, memory and other typical computer components. In some embodiments, the software may reside on a server and operate on various computers or computer terminals. In some embodiments, the software may reside at least partially on a server or cloud-based system or on an internet-based system, where data (songs) may be interchanged with the software of the present invention between the central library and the various karaoke host terminals. Security measures may be included with the software, such as data encryption, to permit the secure exchange of data.

The software of the present invention may include computer code, disposed on a computer readable medium, adapted to perform the various functions as described herewithin.

It should be understood, of course, that the foregoing relates to exemplary embodiments of the invention and that modifications may be made without departing from the spirit and scope of the invention as set forth in the following claims.

What is claimed is:

1. A karaoke system comprising:
a central terminal having a central library of songs;
one or more karaoke host terminals linked to the central library by a data exchange mechanism; and
software disposed in the central terminal, the software being written in computer code and stored on a computer readable medium, the software including program code for sending a requested song to the karaoke host terminal and marking that song as checked out, preventing additional karaoke host terminals from accessing the song.

2. The karaoke system of claim 1, wherein the data exchange mechanism is via the internet.

3. The karaoke system of claim 1, where the software includes program code to show all karaoke host terminals that request a song being played, that the song being played is checked out and not currently available.

4. The karaoke system of claim 1, where the software includes program code to show all karaoke host terminals that a requested song is requested on more than one karaoke host terminal.

5. A computer-implemented method, written as a programmable code, stored on a computer readable medium, and adapted to manage operations of a karaoke system, the method comprising:
linking one or more karaoke host terminals with a central terminal;
receiving a request for a song from a first karaoke host terminal;
downloading the song to the first karaoke host terminal;
marking the song as being checked out while the song is downloaded at the host terminal, thereby preventing another host terminal from downloading the song; and
deleting the song from the host terminal after the song is finished.

6. The method of claim 5, further comprising displaying an indicator on karaoke host terminals that has the checked out song in their playlist.

7. The method of claim 5, further comprising generating a report showing songs that were blocked on one host terminal while being played on another host terminal.

8. A method for preventing unauthorized playing of a karaoke song at multiple locations or on multiple karaoke host terminals at the same time, the method comprising:
linking one or more karaoke host terminals located at multiple locations with a central terminal;
receiving a request for a song from a first karaoke host terminal at a first location;
downloading the song to the first karaoke host terminal that requested the song;
marking the song as being checked out while the song is downloaded to the host terminal, thereby preventing another host terminal at another location from downloading the song; and
deleting the song from the host terminal after the song is finished.

9. The method of claim 8, further comprising linking the karaoke host terminals with the central terminal via the internet.

10. The method of claim 8, further comprising displaying an indicator on karaoke host terminals that has the checked out song in their playlist.
